(19) United States
(12) Patent Application Publication
(10) Pub. No.: US 2002/0113740 A1
(43) Pub. Date: Aug. 22, 2002

(54) Flat-plate monopole antennae

(76) Inventor: Nadar Fayyaz, Nepean (CA)

Correspondence Address: Gowling Lafleur Henderson LLP, Suite 4900, Commerce Court West, Toronto, ON, M5L 1J3, CA

(21) Appl. No.: 09/998,796

(22) Filed: Dec. 3, 2001

Related U.S. Application Data
(63) Continuation of application No. PCT/CA00/00635, filed on Jun. 2, 2000.
(60) Provisional application No. 60/137,150, filed on Jun. 1, 1999.

(51) Int. Cl. H01Q 1/24

(52) U.S. Cl. 343/702; 343/700 MS

(57) ABSTRACT

A monopole antenna includes a conductive ground plane, a conductive radiating plate, an antennae interface terminal, and a resonant network for defining operating characteristics of the antennae. The conductive radiating plate is spaced apart from the ground plane and, together with the ground plane, defines a cavity therebetween. The antennae interface terminal is in communication with the cavity and is electrically isolated from the ground plane and the radiating plate. The resonant network includes an inductive element electrically coupled between the interface terminal and the radiating plate. Preferably, the inductive element is disposed within the cavity and comprises a first air-core coiled wire inductor electrically coupled between the radiating plate and the interface terminal, and a second air-core coiled wire inductor electrically coupled between the interface terminal and the ground plane. Also, preferably each inductor has a number of wire turns, and the resonant network provides the antenna with a resonant frequency determined in accordance with the number of wire turns.

### CROSS-REFERENCE TO RELATED APPLICATION

This application is a continuation of international PCT application PCT/CA00/00635 filed Jun. 2, 2000 which is a continuation of U.S. application 60/137,150 filed Jun. 2, 1999.

### FIELD OF THE INVENTION

The present invention relates to a flat-plate antennae. In particular, the present invention relates to a flat-plate monopole antennae suitable for use with mobile wireless communications devices.

### BACKGROUND OF THE INVENTION

Conventional wireless communications devices, such as cellular telephones, typically use a monopole antennae to transmit and receive electronic information. The conventional cellular monopole antennae comprises a tubular antennae element grounded to the casing of the cellular telephone, and a metal rod disposed within the grounded tubular antennae element. To attain the large gain and bandwidth characteristics required for cellular communication, the monopole antennae must generally be considerably longer than the length of the casing of the cellular telephone. Since a long monopole antennae would inhibit the portability of the cellular telephone, the monopole antennae is typically fabricated as a series of telescoping monopole antennae sections which allow the monopole antennae to be retracted into the telephone casing when the cellular telephone is not in use. However, the monopole antennae must still be extended to obtain the required gain and bandwidth characteristics for cellular communication. Accordingly, attempts have been made to reduce the size of the monopole antennae without compromising antennae gain and bandwidth.

For instance, Yokoyama (U.S. Pat. No. 4,791,423) teaches a microstrip antennae suitable for use with a mobile telephone. The microstrip antennae comprises a first grounding rectangular conductive sheet, a radiating rectangular conductive sheet parallel to the grounding conductive sheet, a feed pin disposed within the substrate between the first grounding conductive sheet and the radiating conductive sheet, and second and third grounding conductive sheets disposed at opposite ends of the first grounding conductive sheet and being perpendicular to the first grounding conductive sheet and the radiating conductive sheet sleeve so as to improve te beam tilt characteristics of the antennae. The second grounding conductive sheet functions as a connecting conductive sheet connecting the first grounding conductive sheet to the radiating conductive sheet. In one variation, shown in FIG. 4a of the patent, the patch antenna includes a planar passive element disposed above and in close proximity to the radiating conductive sheet for facilitating impedance matching of the antenna.

Nakase (U.S. Pat. No. 5,061,939) teaches a flat-plate antenna suitable for use with a mobile telephone. The flat-plate antenna comprises a rectangular conductive ground plate, a radiating oval-shaped conductive top plate parallel to the ground plate, a plurality of elongated connecting members disposed between the ground plate and the top plate for electrically connecting the top plate to the ground plate, and a stripline resonator disposed between the ground plate and the top plate. The stripline resonator includes a feeder line, and a capacitor electrode centrally disposed below the top plate for adjusting the resonant frequency of the antenna.

Yokoyama (U.S. Pat. No. 5,148,181) teaches a mobile radio communications device having an antenna for preventing the antenna gain from being reduced by the user's head and/or hands during operation of the communications device. The antenna is mounted on the upper surface of the casing of the communications device, and comprises a rectangular first conductive plate, a rectangular second conductive plate disposed below and extending parallel to the first conductive plate, and a rectangular third conductive plate extending perpendicularly from the first and second conductive plates. The first conductive plate is spaced a distance from the upper surface of the casing of the communications device. The antenna also includes a short circuit plate extending perpendicularly from the first conductive plate and is connected to the upper surface of the casing in proximity to the location of the earpiece and the mouthpiece.

Boubouleix (U.S. Pat. No. 4,491,843) teaches a dipole antenna comprising a parallelopiped-shaped metal box, an amplifier disposed within the metal box, a metal plate disposed in proximity to the top end surface of the metal box, and an inductor extending through the upper end surface. The inductor is connected at one end to the metal plate and at the opposite end to the amplifier.

Delaveaud (“Small-sized Low-profile Antenna to Replace Monopole Antennas”, Electronics Letters, vol. 34, no. 8, GB, IEE Stevenage, Apr. 16, 1998) teaches a monopole antenna comprising a parallelepiped-shaped metal box, a metal plate and a coaxial feed probe. The metal box has an upper planar grounding surface, and the metal plate is disposed in proximity to the grounding surface. The coaxial feed probe extends through the grounding surface of the metal box. The centre conductor of the probe is connected at one end to the centre of the metal plate. The outer conductor of the probe is connected at one end to the metal plate, and at the opposite end to the grounding surface.

Yokoyama, Nakase, Boubouliex and Delaveaud provide an antenna which is significantly smaller than the conventional telescoping monopole antenna. However, in each case the bandwidth, resonant frequency and input impedance characteristics of the antenna are dictated by fixed parameters such as the dimensions of the conductive plates, and the distance between the conductive plates. As a consequence, close attention must be paid to manufacturing tolerances to attain the proper operating characteristics for the antenna. Therefore, there remains a need for a monopole antenna which is significantly smaller than the conventional monopole telescoping antennae, and whose operating characteristics are not compromised by variations from manufacturing tolerances.

### SUMMARY OF THE INVENTION

According to the invention, there is provided a wireless communications device and monopole antenna which address deficiencies of the prior art monopole antennae.

The monopole antenna according to the present invention includes a conductive ground plane, a conductive radiating plate, an antennae interface terminal, and a resonant network for defining operating characteristics of the antennae. The conductive radiating plate is spaced apart from the ground plane and, together with the ground plane, defines a cavity therebetween. The antennae interface terminal is in communication with the cavity and is electrically isolated from the ground plane and the radiating plate. The resonant network includes an inductive element electrically coupled between the interface terminal and the radiating plate.

The wireless communications device according to the present invention includes a conductive casing for receiving wireless communications hardware therein; a conductive radiating plate spaced apart from the casing and, together with the ground plane, defining an antenna; and a resonant network for defining operating characteristics of the antennae. The conductive casing includes an antenna communication port for interfacing with the communications hardware. The resonant network includes an inductive element electrically coupled between the communication port and the radiating plate.

In a preferred implementation of the invention, the inductive element is disposed within the cavity and comprises a first air-core coiled wire inductor electrically coupled between the radiating plate and the interface terminal, and a second air-core coiled wire inductor electrically coupled between the interface terminal and the ground plane. Each inductor has a number of wire turns, and the resonant network provides the antenna with a resonant frequency determined in accordance with the number of wire turns.

### BRIEF DESCRIPTION OF THE DRAWINGS

The preferred embodiment of the invention will now be described by way of example only, with reference to the drawings, in which:

FIG. 1 is a perspective view of the wireless communications device, according to the present invention, depicting the conductive casing (antenna ground plane), the radiating plate, and the resonant network;

FIG. 2 is a magnified view of the top end of the wireless communications device shown in FIG. 1, depicting the air-cored coiled wire inductors of the resonant network;

FIG. 3 is a longitudinal cross-sectional view of one variation of the wireless communications device, including an arcuately-shaped radiating plate;

FIG. 4 is a side view of another variation of the wireless communications device, including a radiating plate inclined relative to the conductive casing;

FIG. 5a is a schematic view of the wireless communications device including dimensional symbols as used herein, and

FIG. 5b is a magnified schematic view of the top end of the wireless communications device including additional dimensional symbols as used herein.

### DETAILED DESCRIPTION OF THE PREFERRED EMBODIMENT

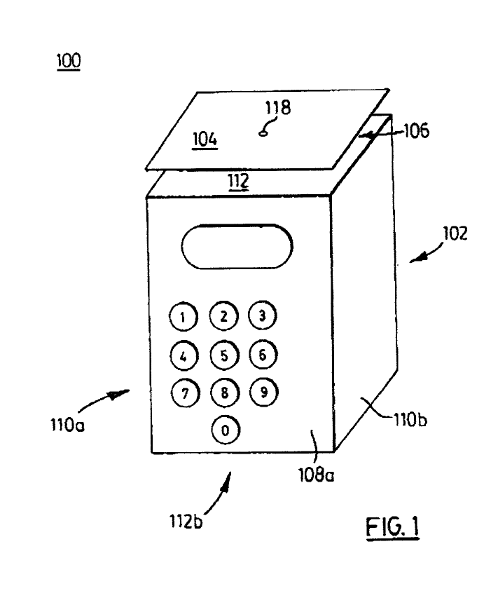

Turning now to FIG. 1, a wireless communications device, denoted generally as 100, is shown comprising a conductive casing 102, a conductive radiating plate 104 spaced apart from the casing 102, and a cavity 106 defined between the casing 102 and the radiating plate 104. Preferably, the casing 102 has a generally rectangular parallelopiped shape, configured for receiving wireless communications circuitry therein, and includes a pair of opposite faces 108a, 108b, a pair of opposite sides 110a, 110b, and a pair of opposite ends 112a, 112b. Also, preferably the casing 102 is shaped as a wireless telephone handset, and the wireless communications circuitry housed within the casing 102 operates as a wireless telephone. However, it will be appreciated that the casing 102 may adopt other shapes and the wireless communications circuitry may function other than as a wireless telephone, as the application demands.

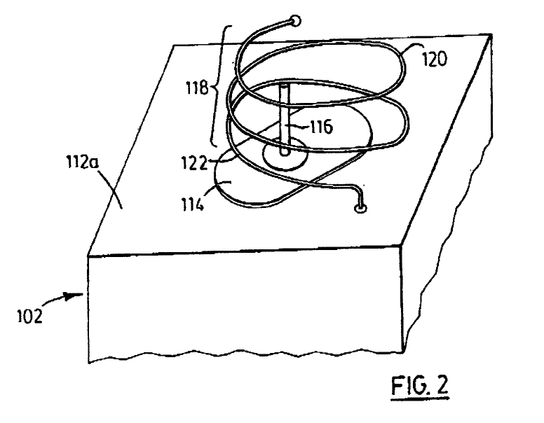

As shown more clearly in FIG. 2, the casing 102 includes an antenna communication port 114, and an antenna interface terminal 116 extending through the communication port 114. The interface terminal 116 extends into the cavity 106, and is electrically isolated from the casing 102 and the radiating plate 104. In addition, the interface terminal 116 interfaces with the communications hardware disposed within the casing, 102, and allows the communications hardware to transmit and receive data as electromagnetic waves.

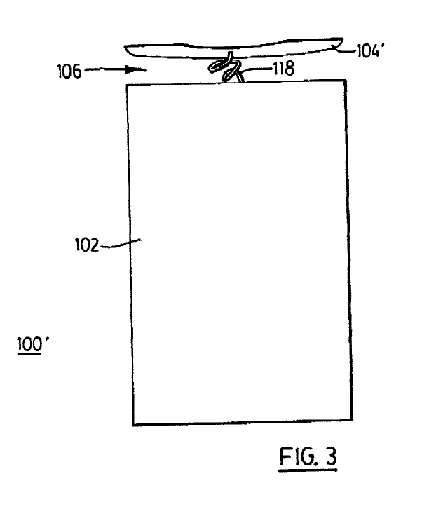

The radiating plate 104 cooperates with the casing 102 to define a monopole antenna, with the casing 102 acting as the conductive ground plane for the antenna. Preferably, the radiating plate 104 comprises a rectangular planar conductive plate fabricated from copper or aluminum. However, the radiating plate 104 may adopt any other shape suitable for proper antenna operation. For instance, in one variation, shown in FIG. 3, the radiating plate is fabricated with an arcuate shape. Further, the radiation plate 104 may have the same or different dimensions as the casing 102.

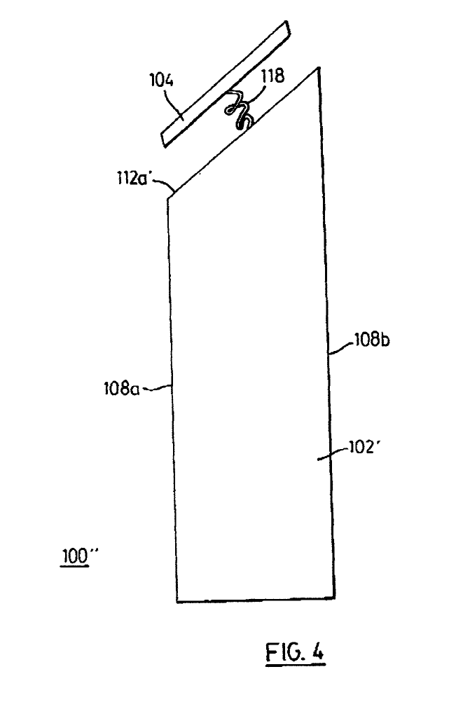

As shown in FIG. 1, preferably the radiating plate 104 is oriented substantially parallel to the casing ends 112 and at right angles to the casing faces 108. However, the radiating plate 104 may also be disposed at other angles relative to the casing faces 108 so as to alter the antenna pattern of the, monopole antenna. For instance, in FIG. 4, there is shown a wireless communications device 100′ in which the end 112a′ and the radiating plate 104 are inclined relative to the casing faces 108. Alternately, the radiating plate 104 may be inclined slightly with respect to the casing end 112a.

As shown in FIGS. 1 and 2, the wireless communication device 100 also includes a resonant network 118 which, in conjunction with the dimensions of the radiating plate 104 and the cavity 106, defines the operating characteristics of the monopole antennae. The resonant network 118 is disposed within the cavity 106, and includes an inductive antenna element electrically coupled to the interface terminal 116, the radiating plate 104 and the casing 102. However, it should be understood that the resonant network 118 is not limited to including only a single inductive antenna element. For instance, in one variation (not shown), in order to increase the bandwidth of the antenna, the resonant network 118 includes a plurality of distinct inductive antenna elements, each being electrically connected to the interface terminal 116 and respective locations on the radiating plate 104 and the casing 102

The inductive antenna element comprises a first inductor 120 electrically connected between the radiating plate 104 and the interface terminal 116, and a second inductor 122 electrically connected between the interface terminal 116 and the casing 102. Preferably, the first inductor 120 and the second inductor 122 are coupled together on a common core.

The resonant network 118 also includes a capacitive antenna element which is defined by the dimensions of the casing 102, the radiating plate 104 and the cavity 106. The inductive antenna element is disposed in parallel with the capacitive antenna element, with the capacitive antenna element and the inductive antenna element together establishing a parallel resonant circuit. As will be apparent, the resonant frequency of the monopole antenna is determined in accordance with the capacitance of the capacitive antenna element and the inductance of the inductive antenna element.

Preferably, the cavity 106 comprises an air cavity, and the inductors 120, 122 comprise air-cored coiled wire inductors, each having a respective number of wire turns so that the resonant frequency of the monopole antenna is defined by the number of wire turns of each inductor 120, 122. Alternately, the cavity 106 may include a dielectric or a support structure which supports the radiating plate 104. Also, preferably the wire used in the wire inductors 120, 122 comprises flexible wire so as to allow the distance between the radiating plate 104 and the end 112a (and therefore the capacitance of the capacitive antenna element) to be adjusted. In this manner, the resonant frequency of the monopole antenna can be adjusted to account for variations in manufacturing tolerances.

As will be appreciated, the input impedance of the monopole antenna is dictated by the number of wire turns (and hence the inductances) of the wire inductors 120, 122. On the other hand, the capacitance of the capacitive antenna element is dictated by the size and shape of the radiation plate 104 and the casing 102. Accordingly, the present invention offers the significant advantage of allowing the input impedance of the monopole antennae to be matched to that of the wireless communications circuitry by adjusting the number of wire turns, while also allowing the resonant frequency and bandwidth of the antenna to be adjusted as desired by altering the dimensions of the radiation plate 104 and/or the casing 102. In each case, however, preferably the length and width of the radiation plate 104 and the end 112a remains less than 10% of the operating wavelength of the antenna at the resonant frequency.

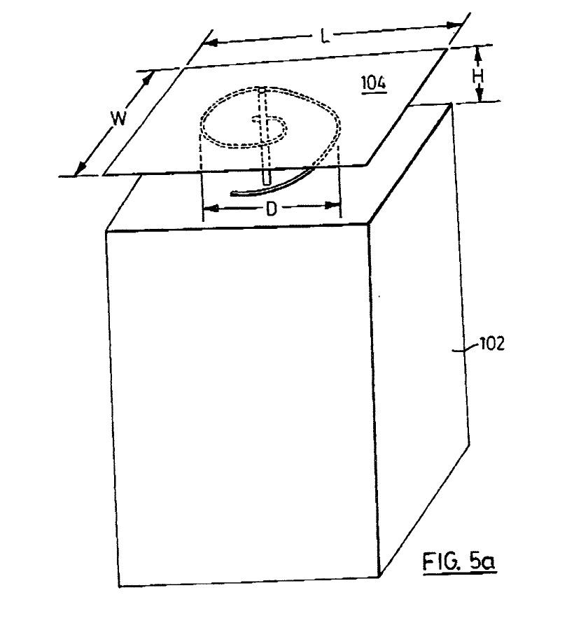

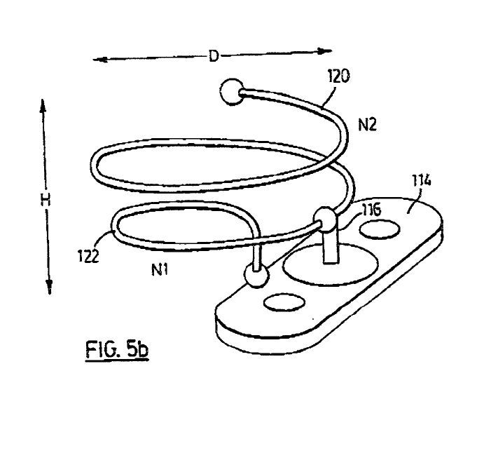

The following table describe sample resonant frequencies obtained using several different dimensional variations of the present invention. For reference, the symbols W, L, H, D, N1, and N2, as used below, are depicted in FIGS. 5a, 5b. Given that the antenna length of the conventional cellular telephone is approximately 77 mm (operating in the GSM band), the following table demonstrates the substantial height reductions also attainable with the present invention.

| FREQ. | W* | L* | H* | D* | N1 | N2 | TYPE |
|---|---|---|---|---|---|---|---|
| 850 | 47 | 23 | 9.5 | 4.2 | 0.6 | 1.4 | Cellular |
| MHz | | | | | turns | turns | |
| 1800 | 23 | 8 | 4.5 | 2.3 | 0.6 | 1.4 | PCS |
| MHz | | | | | turns | turns | |
| 850 | 37 | 20 | 10 | 5.2 | 0.5 | 1.5 | Cellular |
| MHz | | | | | turns | turns | |
| 1800 | 23 | 8 | 4.5 | 2.3 | 0.6 | 1.4 | PCS |
| MHz | | | | | turns | turns | |

*= all dimensions are in millimeters (mm)

The present invention is defined by the claims appended hereto, with the foregoing description being merely illustrative of the preferred embodiment of the invention. Those of ordinary skill may envisage certain additions, deletions and/or modifications to the described embodiment, which although not explicitly described herein, do not depart from the spirit or scope of the invention, as defined by the appended claims.

I claim:

1. A flat-plate monopole antenna comprising:
a conductive ground plane;
a conductive radiating plate spaced apart from the ground plane and, together with the ground plane, defining a cavity therebetween;
an antennae interface terminal in communication with the cavity and being electrically isolated from the ground plane and the radiating plate; and
a resonant network for defining operating characteristics of the antennae, the resonant network including an inductive element electrically coupled to the interface terminal and the radiating plate.

2. The monopole antenna according to claim 1, wherein the ground plane, the radiating plate and the cavity define a capacitive element, and the inductive element is disposed in parallel with the capacitive element.

3. The monopole antenna according to claim 1, wherein the inductors are disposed within the cavity.

4. The monopole antenna according to claim 1, wherein at least one of the inductors comprises an air-core inductor.

5. The wireless communications device according to claim 1, wherein the inductors comprise coiled wire inductors, each said coiled wire inductor including a number of wire turns, and the resonant network provides the antenna with a resonant frequency determined in accordance with the number of wire turns of the coiled wire inductors.

6. The monopole antenna according to claim 1, wherein the resonant network includes a plurality of distinct inductive elements each being electrically coupled to the interface terminal and a respective location on the radiating plate.

7. The monopole antenna according to claim 1, wherein the radiating plate comprises an arcuate radiating plate.

8. A wireless communications device comprising:
a conductive casing for receiving wireless communications hardware therein, the conductive casing including an antenna communication port for interfacing with the communications hardware;
a conductive radiating plate spaced apart from the casing and, together with the ground plane, defining an antenna; and
a resonant network for defining operating characteristics of the antenna, the resonant network including a first inductor electrically coupled between the radiating plate and the communications port, and a second inductor electrically coupled between the communications port and the casing.

9. The wireless communications device according to claim 8, wherein the casing, the radiating plate and the cavity define a capacitive element, and the inductors are disposed in parallel with the capacitive element.

10. The wireless communications device according to claim 8, wherein the radiating plate and the casing together define a cavity therebetween, and the inductors are disposed within the cavity.

11. The wireless communications device according to claim 8, wherein at least one of the inductors comprises an air-core inductor.

12. The wireless communications device according to claim 8, wherein the inductors comprise coiled wire inductors, each said coiled wire inductor including a number of wire turns, and the resonant network provides the antenna with a resonant frequency determined in accordance with the number of wire turns of the coiled wire inductors.

13. The wireless communications device according to claim 7, wherein the resonant network includes a plurality of distinct inductive elements each being electrically coupled to the communications port and a respective location on the radiating plate.

14. The wireless communications device according to claim 7, wherein the casing includes at least one face, and the radiating plate is inclined relative to the at least one face.

15. The wireless communications device according to claim 7, wherein the radiating plate comprises an arcuate radiating plate.
